(19) United States
(12) Patent Application Publication
(10) Pub. No.: US 2011/0011387 A1
(43) Pub. Date: Jan. 20, 2011

(54) MULTIPLE FUNCTION CROSS-DRAFT CONVECTION OVEN/GRILLING SYSTEM

(76) Inventor: Jerry Sawaya, St. Petersburg, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 12/505,695

(22) Filed: Jul. 20, 2009

(51) Int. Cl. A47J 37/07

(52) U.S. Cl. 126/25 AA

(57) ABSTRACT

A multiple function convection oven/grilling system comprising a chamber, which is rotatably mounted on a stand. The invention includes a stand, a rotatable cylindrically-shaped chamber, a removable cover, a removable grilling/cooking surface, a fuel support rack for hold charcoal or wood, a detachable extension to the front side of the fuel support rack that form a basket for preventing the fuel source from falling off the fuel support rack when the chamber is rotated such that the fuel source is oriented between a six o'clock position at the bottom of the chamber to a nine o'clock position. The chamber includes a rotation positioning holding feature in the form of a notched plate that engages elongate pins extending from one of the opposing ends of the cylindrical chamber.

### FIELD OF THE INVENTION

The invention relates to an outdoor grilling system configured to be used as a convention oven.

### BACKGROUND OF THE INVENTION

There are several charcoal/wood burning outdoor grills known in the art that can be used by campers, tailgaters and backyard grill masters. However, when the covers are closed, the cooking is still predominantly done from the direction underneath the food being cooked, that is, where the charcoal or wood is located on the underlying grate. They do not provide true convection cooking nor are they designed to provide for the appearance of an outdoor fireplace when the cover is removed. In fact most covers are opened with a hinged device, even though they are generally removable for maintenance.

### SUMMARY OF THE INVENTION

The invention is a portable wood or charcoal fired cooker/fireplace designed for campers, tailgaters, and backyard grill masters looking for a multifunctional cooker which also provides the warmth, beauty, and charm of an outdoor fireplace. More specifically, it is configured to be selectively configured so as to be used as a convection oven. In this same configuration, it can be used as an outdoor fireplace (without the cover being used).

A generally cylindrical shaped barrel, typically made from steel or cast iron material, is mounted horizontally on a stand having rollers upon which the barrel engages and is allowed to rotate a desired arcuate distance, such as four to six inches, depending on the size of the drum or barrel being used. Certainly a barrel size approximating a 35 gallon capacity will require an arcuate distance which is less than a barrel size approximating a 55 gallon capacity just from the very nature of the respective perimeter distance of each barrel size. In any event, it is preferred that the barrel be capable of being rotated such that the fuel source at the 6 o'clock position is effectively moved to be near the 8 o'clock to 9 o'clock position relative to the grilling/cooking surface.

A saddle-shaped cut or formed opening in the drum is provided to expose the fire pit. A removable cover is provided that is generally sized a little less in width than the saddle shaped formed opening. The cover can be provided by using the removed section from a complete drum structure. The cover is generally suspended by resting an intermediate portion of the cover on spaced-apart brackets and/or pins mounted within the opening. The saddle-shaped opening is formed where the back side of the barrel is higher than the front side of the barrel a desired distance. This feature enhances the cross-draft of the system and the ability of the invention to be used as a fireplace when the barrel is rotated as discussed below or when the invention is to be used as convection oven with the cover in place.

The coal/wood grate is positioned, a fuel such as wood or charcoal is placed on the grate, the fire is lit and the grilling or cooking surface grate is suspended over the fire. This is the typical “grill position” where temperatures can range from normal to very hot.

The grilling grate is mounted inside the barrel chamber and the mounting is configured to allow the grilling grate to be rotatably suspended such that as the barrel itself is rotated, the grilling surface remains horizontally oriented. For example, the grilling grate may be suspended from two opposite facing rods that lock the grate in place but allows for a swinging suspension like a swing so that as the barrel is rotated, the cooking grate stays horizontal and partially sticks out the front opening of the barrel front edge opening. The grilling grate may be in the form of a mesh with diamond shaped openings or it may be a typical grate comprising parallel bars interconnected together such as that found in most grills. It is preferred that the grilling grate have generally upward directed sides and upward directed front and back edges to prevent any food item being grilled or cooked from sliding off the grate. It is also preferred that the upward directed sides of the grilling grate have spaced-apart notches for engaging the front edge end portions of the cover when the cover is being used.

The coal/wood grate is generally curved shaped and when placed into the barrel chamber is spaced-apart from a bottom surface of the barrel chamber a sufficient distance to allow air to generally flow underneath the fuel source. Appropriately located spacing members, rods, gussets, brackets, etc., may be fixed to the bottom of the chamber to make sure the coal/wood grate does not rest directly on the chamber bottom surface. The coal/wood grate may be in the form of a mesh with diamond shaped openings or it may be a typical grate comprising parallel bars interconnected together such as that found in most grills. The coal/wood grate is held in place so it cannot slide as the barrel is rotated forward. Typically, this can be done in a number of ways, such as using a hook type of attachment member or an extended protrusion that protrudes into two or more of the grate openings. The intermediate portion of the coal/wood grate also includes a detachable feature, an inwardly directed angular shaped coal/wood retention extended portion that extends along the complete width of the coal/wood grate. This extended coal/wood retention portion can be attached using hook shaped attachment members which engages an opening of the coal/wood grate or flange ends with hook engaging members that attach to the primary coal/wood grate. When attached, a chute or basket is generally formed into witch the coal or wood can be captured and prevented from falling to the bottom of the chamber when the chamber is rotated. Effectively, an angle of about 45 degrees to up to 90 degrees can be formed between the detachable grate and the main grate.

With the rotation of the drum toward the person doing the cooking and with the use of the coal/wood retention portion, the fire or fuel source moves with the drum upwardly in a general direction toward the back side of the grilling grate, which in turn swings out and transforming the cooking surface from a direct fire to an indirect fire orientation. This rotation gives the griller the ability to move the food from a very hot direct fire to an indirect fire.

An air vent is provided on one of the sides of the barrel. The air vent is typically located near the bottom of the side of the barrel so air can flow into the barrel, under the fuel source and up through the grilling surface grate and up along the inside circumferential surface of the barrel behind the grilling surface grate to create a circulation of hot air around the food being cooked. When the cover is on and where the back side of the saddle shaped opening in the chamber is higher than the front side, there is a natural draft of air that passes under the front edge of the cover, through the fuel grate, around the back side of the chamber creating a cross-draft convection unrestricted air flow where the cover effectively acts as a damper.

As mentioned above, the barrel is mounted horizontally on a stand with rollers. This allows the rotation of the drum which controls air flow and fire location. In the grilling position the fire is directly below the cooking surface and performs as a normal grill with a bonus. The cross-draft induction system allows you to reach very high temps if desired. When the drum is rotated the fire moves to an indirect position where the food continues to cook from the indirect fire and the convection created as the air drawn in swirls around the inside of the drum.

A chute or coal/wood retention portion as discussed above, holds the coals or wood for convection cooking and allows the user to cook without fear of burning the food. When lower temps are desired, the placement of the cover allows heat to escape and shields the food so that temperature increments from 100° F. or less to 600° F. plus can be maintained to accommodate any cooking requirement.

The placement of the air intake and the air gap at the cover front and back edges in relation to the unique saddle cut out, and the rotation of the drum effectively results in a cross-draft induction system that creates convection. With the cover that is placed in position with its top edge resting on the top of the fire pit opening, its bottom edge in the accompanied slots on the cooking basket, thus closing the fire pit, a convection oven is created with temperatures being controlled by the movement of the cover in the accompanied slots, which create an opening or vent along the top edge of the fire pit allowing controlled volumes of hot air to escape. The cover also shields the food from full convection allowing for an array of cooking temperatures from searing to resting.

As a representative example of the invention, assuming the invention is sized to be the equivalent of a 35 gallon steel drum with a 19″×12″ saddle mounted horizontally on a stand that allows for a 5″ rotation of the drum. A 19″×12″ saddle cut from the side of the drum provides internal access and the cut out can effectively become the cover. Through the access hole a grate is installed and a 18″×12″ cooking grill is suspended from brackets with locking rods above the fire. This is the grilling position. The fire is direct and can reach very high temperatures. With the 5″ rotation of the drum the fire becomes indirect as it rotates with the drum and the suspended grill swings out away from the fire to prevent flare-ups. The unique cross-draft design creates air convection creating a strong, swirling, draft that results in easy starting and very hot temperatures for searing. The cooker was designed to deliver optimum air to the fire through a cross-draft induction system resulting in an easy lighting grill whose moderate to hot fires sear steaks in moments and holds food for hours. In the grilling position, the fire is directly below the food and operates as a normal charcoal grill. To go from a direct heat source to an indirect heat source the drum is rotated. This rotation moves the fire from a 6 o'clock position up to a 9 o'clock position and the suspended grill swings to a position horizontal to the fire. The food now receives indirect heat from the fire and convection heat that is created by the flow of air in the drum. This convection is directed and the temperature controlled by the cover. When the opening in the drum is covered the cycle is complete and true convection takes place. The high volume movement of air swirling around inside the drum ensures even side to side front to back cooking. To lower the temperatures, the cover can be repositioned thus allowing hot air to escape over the cover. A 400° oven can become a 200° resting area where prolonged low temperature cooking occurs. Increments of 25° from 200° to 350° plus allows for a wide range of cooking needs. It is understood that barrel chambers smaller or larger than that of the above example, will have corresponding dimensions to accommodate the size of the chamber.

Heat resistant barrel rotating means are provided to facilitate the desired rotation of the barrel. This can be done in a number of ways, including by providing a lever or handle on at least one side of the barrel or on the surface of the barrel itself between the opening and the side end of the barrel. Similarly, the removable cover can be enabled using a heat resistant handle fixed to the cover. In addition, means for monitoring the heat inside the barrel when used as a convection oven can be optionally provided by the installation of a heat gauge mounted to the cover or to the barrel at an appropriate location sufficient to obtain a reasonable representation of the cooking temperature inside the invention when used in a convection oven configuration.

The stand can be made in a number of configurations, however it should be rigid and cradle shaped with rollers at the upper end of the cradle against which the barrel comes in contact and can be rotated. Means for locking the barrel position in a normal grilling position and selectively in a rotated position are provided. One simple example of such means is the inclusion of a pivotable lever that has two spaced-apart notches near the pivot portion of the lever. The lever should be generally curved to easily slide along the inside contour of the lip of one of the ends of the barrel. A pin is mounted on the barrel end so as to engage one of the notches of the lever when the barrel in the grilling position. A second pin is mounted on the barrel end so as to engage the second notch of the lever when the barrel is rotated as discussed above.

A transport cover is also provided that can be used to grab the chamber shortly after its use. The transport cover is a saddle-shaped shroud that is configured to drape over the chamber with a center handle at its apex and opposing hooks at the side edges of a apex, where the opposing hooks are configured and size to engage with handles on the opposing upper ends of the chamber. This will ensure that the side of the chamber itself does not come in contact with a person's leg or torso when moving the chamber. The transport cover will also provide for weather protection and alleviate the fear of late night embers blowing out of the barrel.

### BRIEF DESCRIPTION OF THE DRAWINGS

In the accompanying drawings:

FIG. 1 is a perspective conceptual top left isometric depiction of the invention with the cover down with the chamber in a standard grilling position;

FIG. 2 is a perspective conceptual depiction of the invention of FIG. 1 with the cover elevated to view the grilling grate;

FIG. 3 is a top right isometric view in standard grilling position with a close up of the nipple holes of the bracket for the grilling grate;

FIG. 4 is a side sectional view taken from FIG. 1;

FIG. 5 is a conceptual top left isometric depiction of the invention in a rotated position for potential use in convection cooking or use as a fireplace with the cover lifted off;

FIG. 6 is a top left isometric view of the invention in rotated position similar to FIG. 5 with cover replaced;

FIG. 7 is a top right isometric view in rotated position with close up of the nipple holes of the bracket and locking pin for the grilling grate to lock the grilling plate in level position;

FIG. 8 is a side sectional view taken from FIG. 6; and

FIG. 9 is a top left isometric view in of the invention in a conventional standard grilling position with an alternate transport cover attached for moving while hot.

### DETAILED DESCRIPTION OF THE INVENTION

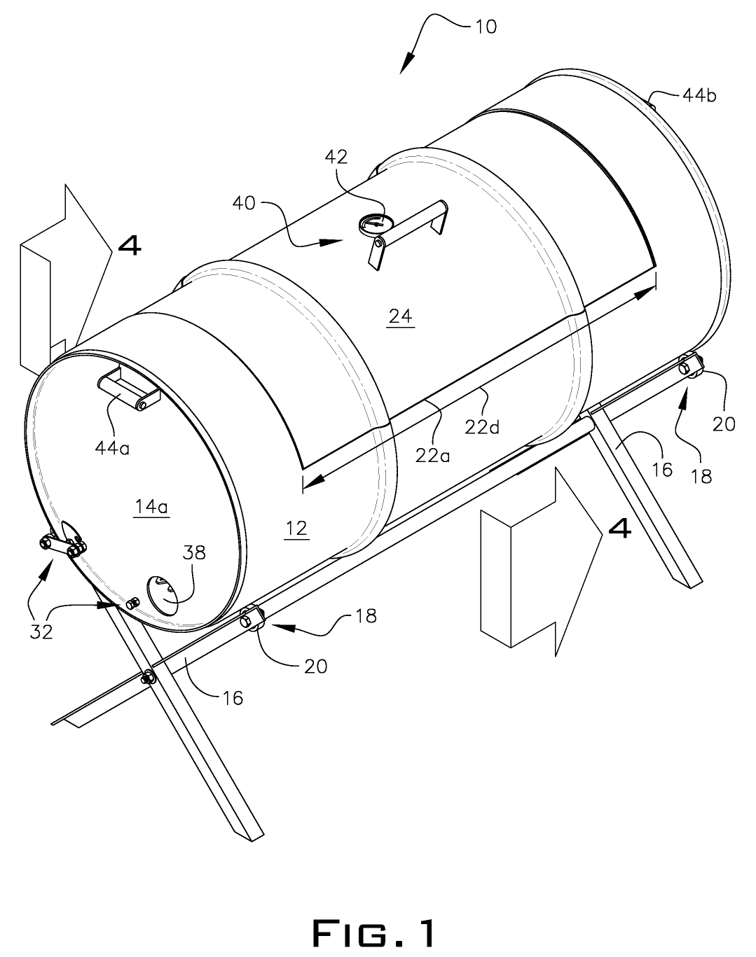

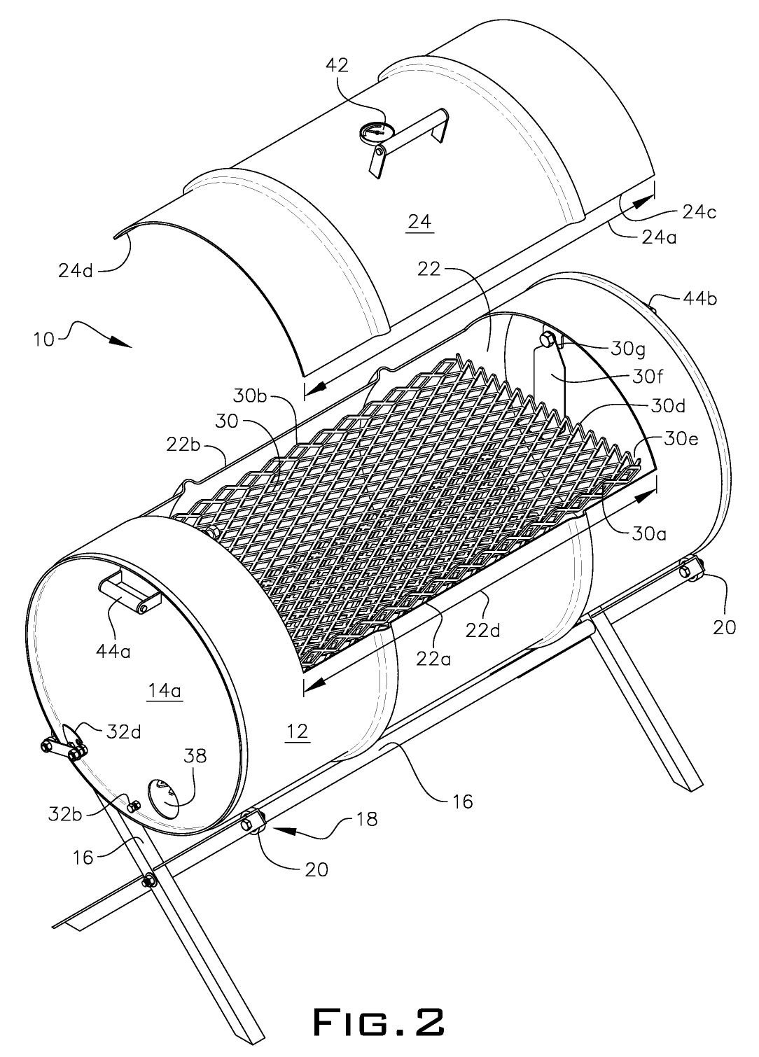

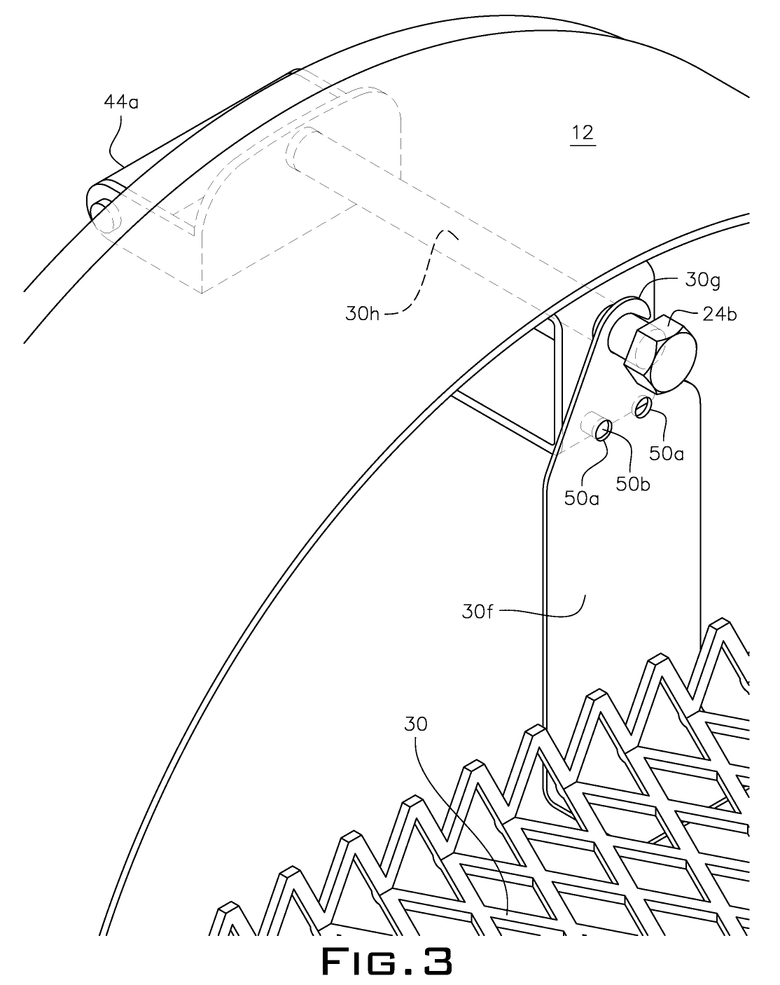

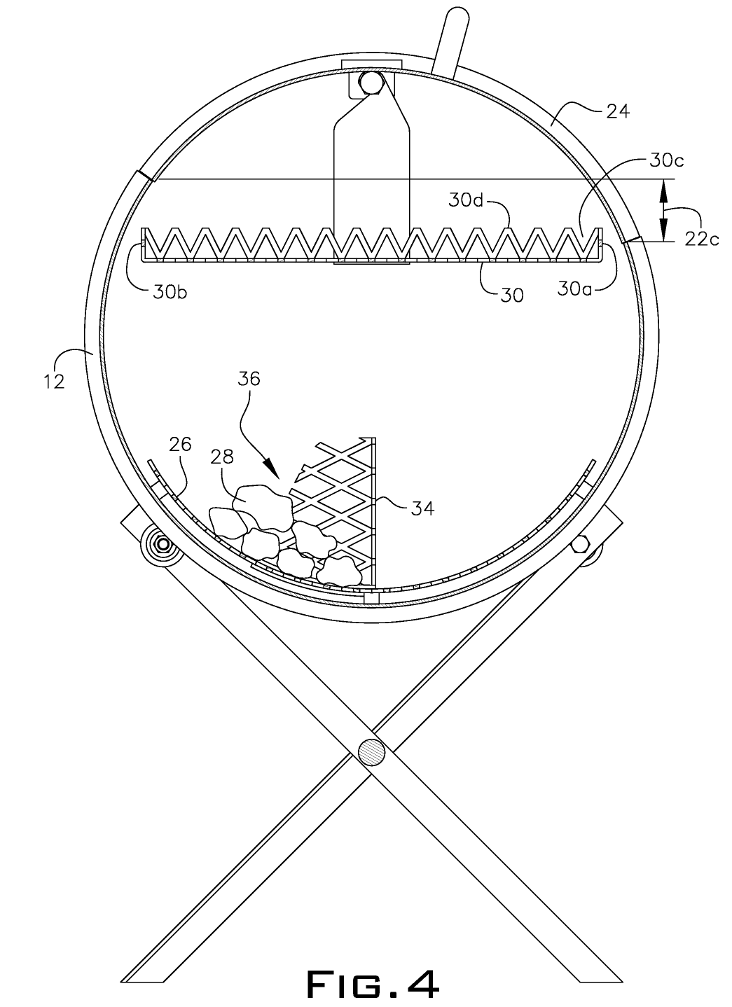

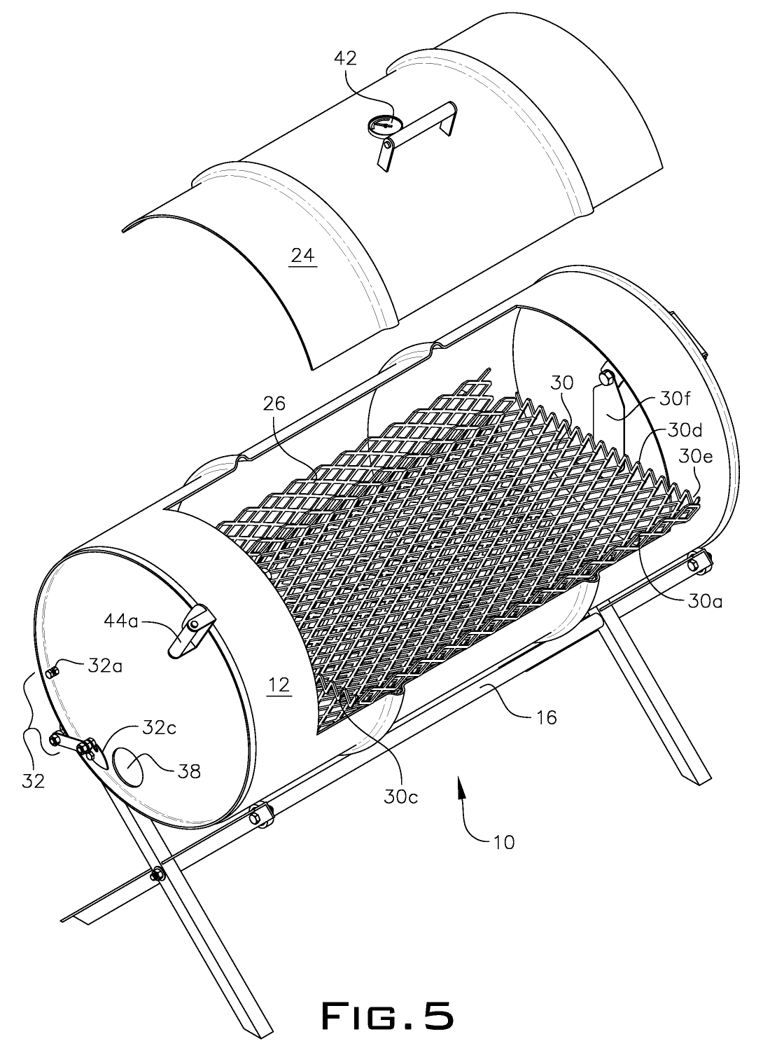

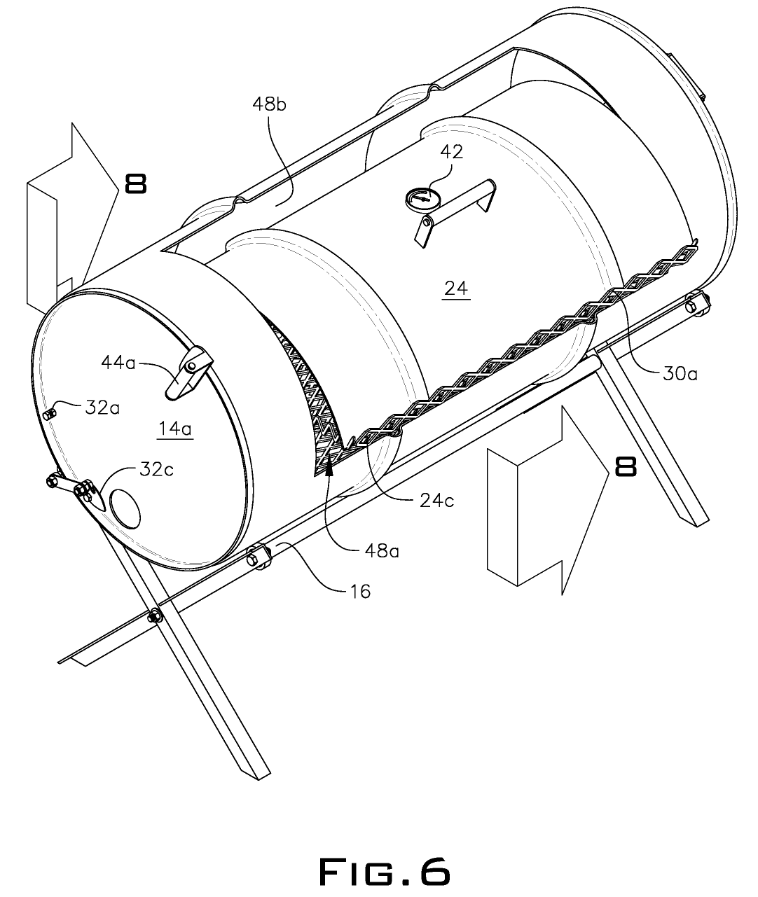

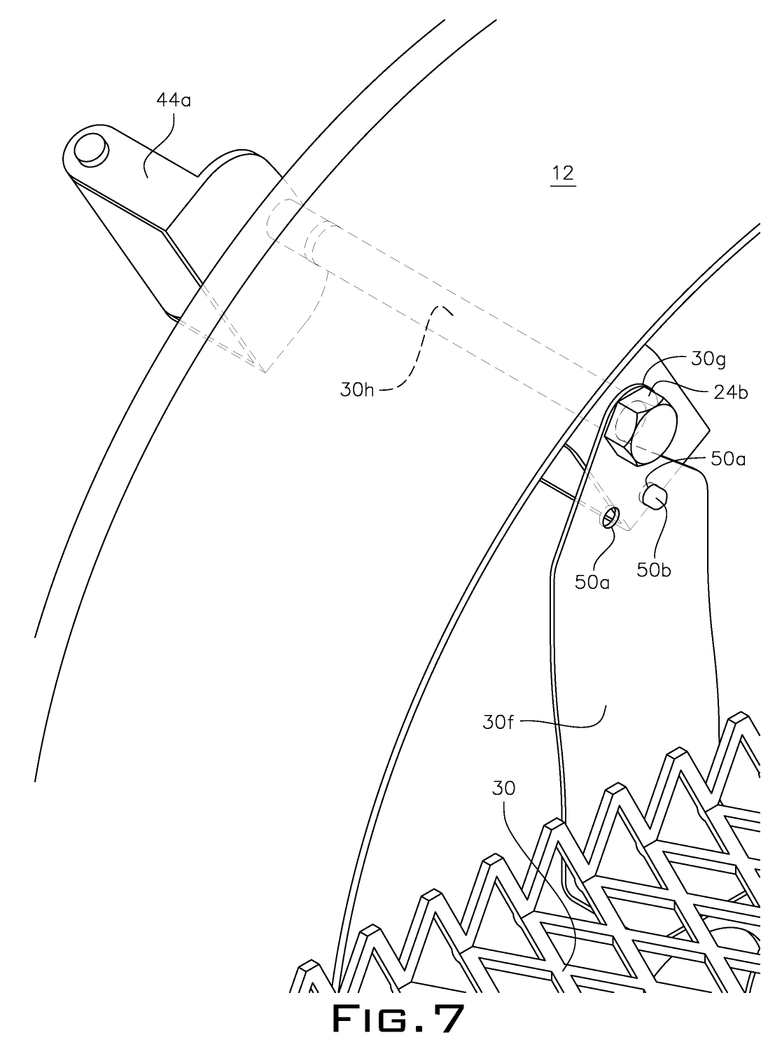

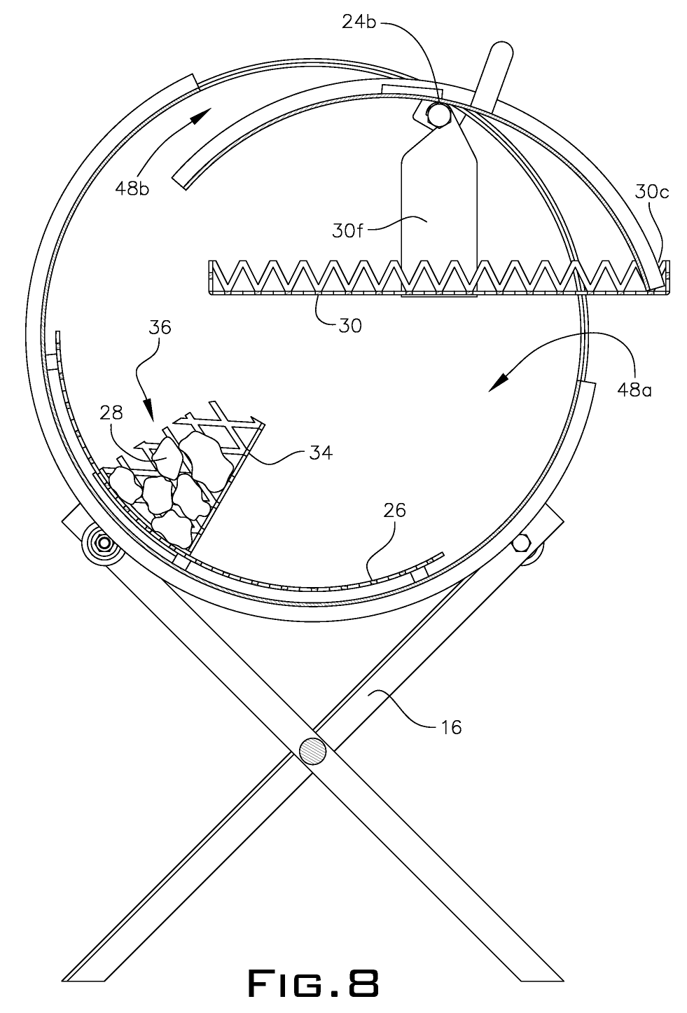

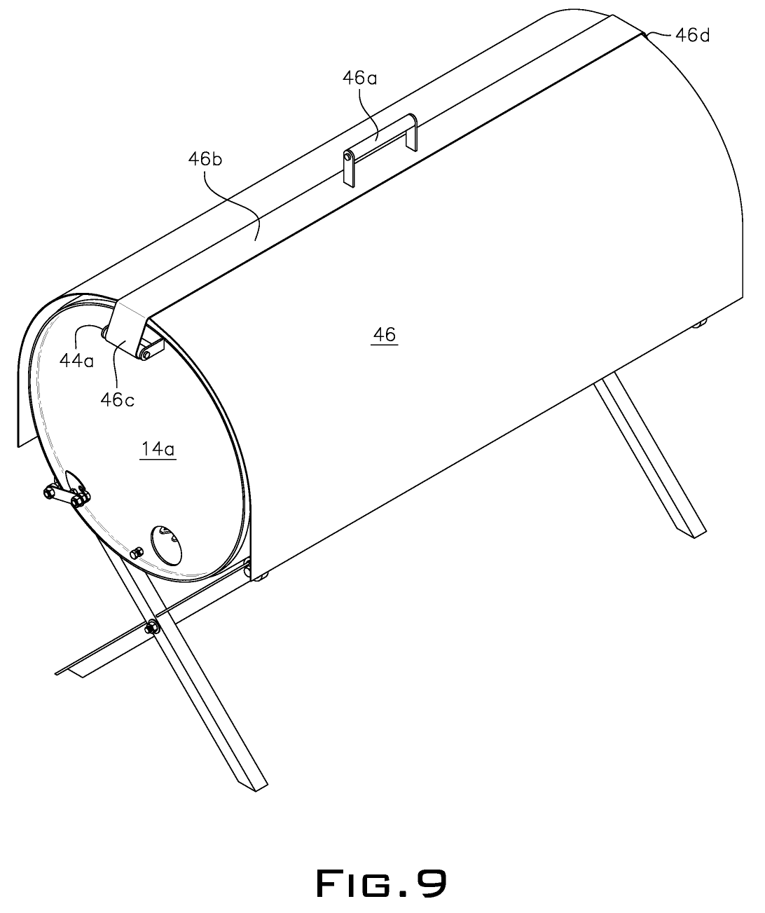

Referring now to the drawings, FIGS. 1-9 disclose representative conceptual depictions of the present invention, which is a multiple function convection oven/grilling system, depicted generally as 10.

The multiple function convection oven/grilling system 10 comprises a chamber 12 having an elongated generally cylindrical shape with two spaced-apart opposed ends 14a,14b. The chamber 12 is rotatably mounted on a stand 16, which includes means 18 for facilitating a rotation of the chamber 12 about a central axis of the chamber 12. There are several ways known in the art to provide this functional feature such as mating tracks between the stand 16 and chamber 12. Preferably, this function can easily be provided by the placement of rollers 20 on the stand 16 as further discussed hereinafter.

The chamber 12 has a saddle-shaped opening 22 at an intermediate portion of the chamber 12. Typically, the opening 22 can extend across a substantial portion of the chamber upper half The front of the opening 22 preferably extends from a first predetermined longitudinal level 22a on a front side of the chamber (close to or near the center planar line of the chamber 12) to a second predetermined longitudinal level 22b on a back side of the chamber 12. Although this second level can be located close to or near the center planar line of the chamber 12 but on the back side, in a preferred embodiment, the second predetermined longitudinal level 22b is located at an elevation a predetermined distance 22c from the first predetermined longitudinal level 22a on the front side of the chamber 12. For example, a distance 22c of three to eight inches will provide enhanced cross-drafting, heating and convection characteristics, especially when the chamber is rotated.

The invention 10 includes a suspendable removable cover 24 having a radius approximating a radius of the elongate cylindrical shaped chamber 12 and configured and sized to have a width 24a dimension less than a width of said saddle-shaped opening 22d. The cover 24 can be suspended in a number of ways such as by providing opposing brackets, appendages or extended pins or rods 24b attached to the chamber 12 near the top of the opening 22 on which the cover 24 can simply be placed to rest upon.

The invention 10 further includes a fuel support rack 26 for placing a charcoal or wood fuel (collectively represented by the number 28) thereon. The fuel support rack 26 is configured to be placed in a spaced-apart overlying relationship to a bottom surface of the chamber 12. This can be done by simply having risers, gussets, spacer rods or plate stock, and the like on the bottom of the chamber 12. It is preferable that the rack 26 be capable of interlocking or otherwise engaging any such risers, gussets, spacer rods or plate stock, and the like so that when the chamber 12 is rotated, the rack 26 will not slide downwardly. Using a grate as a rack 26 which has diamond shaped openings certainly facilitates the engagement of the openings with any appendage on the chamber 12 that can interlock or engage with the rack 26.

The system 10 further includes a suspendable food cooking grate 30 that is removably mounted in a horizontal position in an interior of the chamber 12. The cooking grate 30 is configured to maintain its horizontal position or orientation when the chamber 12 is rotated. Cooking grate 30 may have brackets on either side that are adapter or otherwise configured to be hung from opposing spaced-apart appendages within the chamber 12 (such as hook shaped brackets) that will allow the cooking surface to stay horizontal as the chamber 12 is rotated.

The stand 16 is configured so as to cradle the chamber 12 into a frame structure of the stand 16. On example of such a cradle configured stand is shown in the drawings where the frame structure is X-shaped on each end with an intermediate connecting rod between opposing X-shaped ends. An advantage of such a stand configuration, the invention can be broken down for shipping into components and the stand can also be bolted together and unbolted where the X-shaped ends can come off and be rotated together.

The means 18 for facilitating a rotation of the chamber 12 about the central axis of the chamber 12 can be provided in a number of ways known in the art, including utilizing chain belts, ball bearings and the like. However, a preferred method is to simply incorporate rollers 20 at an upper portion of the stand 16. In the drawing example, the rollers are attached to the upper ends of the stand's X-shaped opposing legs, where the cylindrical shaped surface of the chamber 12 rests on the rollers 20.

The means 32 for holding the chamber 12 in a first position wherein the charcoal or wood fuel 28 is in a six o'clock underlying relationship to the food cooking grate 30 and for holding the chamber 12 in a rotated second position wherein the charcoal or wood fuel 28 is in an intermediate orientation between six o'clock and nine o'clock relative to the food cooking grate 30 can also be provided in a number of ways such as the use of interlocking notches or gears, pins that can be inserted to from the stand into a hole in the side of the chamber 12 and other similar means known in the art. One preferred method is the use of pins or rods 32a,32b extending from the side of the chamber 12 that are individually engaged by a pivotable lever 32c attached to the stand 16 where the lever 32c has two spaced-apart notches 32d near the pivot portion of the lever 32c. The lever 32c should be generally curved to easily slide along the inside contour of the lip of one of the ends of the barrel chamber 12, if such a lip configuration exists.

It is preferred that the fuel support rack 26 be configured to be generally arcuate shaped or curved or otherwise have upright front and back edges to have the same effect as being arcuate-shaped. Such a rack 26 should have openings to allow for ashes to fall through to the bottom of the chamber 12 for eventual clean out.

A detachable fuel support rack portion 34 is provided and is configured to be attached to a front edge of the fuel support rack 26. The detachable fuel support rack portion 34 should be directed inwardly so as to form a fuel holding basket portion 36 for preventing the charcoal or wood fuel 28 from falling off the fuel support rack 26 when the chamber 12 is rotated. There are many ways to incorporate the detachable fuel support rack portion 34 with the support rack 26, such as having extended spaced-apart brackets that engage with the support rack 26, or hook type of prongs or extensions attached to either the rack 26 front edge or to the detachable rack 34 back edge that engage with openings in the respective rack 26 or 24. The actual design of such engagement features is a matter of design choice of the manufacture.

In a preferred embodiment, the food cooking grate 30 further comprises different front, back and side upright edges. For example, an upright front edge 30a may be incorporated, an upright front edge 30a and an upright back edge 30b may be incorporated, an upright left side edge 30c and an upright right side edge 30d may be incorporated, or a combination of any of these edges may be incorporated with the basic grate 30.

In a preferred embodiment, an upright left side edge 30c and an upright right side edge 30d is further incorporated and it also comprises a plurality of spaced-apart notches 30e extending from a front edge of the food cooking grate 30 along at least a portion of the respective upright left and right side edges 30c,30d. The spaced-apart notches 30e are preferably configured to receive respective ends of a front edge 24c of the cover 24.

An air vent 38 serving as an air intake in the form of an aperture is preferably provided. For example, such an air vent can be incorporated in the form of an aperture located near a bottom edge of one of the spaced-apart opposing ends. In the drawings, air vent 38 is an aperture 1 inch to 3 inches in diameter located on one or both of the opposing ends 14a,14b.

The suspendable removable cover 24 is configured to rest along an intermediate line of said removable cover 24 on supporting members 24b such that an air gap 48a is created for additional air intake between the front edge 24c of the removable cover 24 and the first predetermined longitudinal level 22a of the saddle-shaped opening 22 and another air gap 48b for exhausting heat and smoke between a back edge 24d of the removable cover 12 and the second predetermined longitudinal level 22b of the saddle-shaped opening 22.

The suspendable food cooking grate 30 further comprises opposing upright members 30f with a J-shaped hook 30g at respective upper ends of the opposing upright members 30f. The J-shaped hooks 30g are configured to rotatably engage respective mating support pins 30h.

The opposing upright members 30f further comprise means 50 for preventing the suspendable food cooking grate 30 from swinging. The means 50 for preventing the suspendable food cooking grate 30 from swinging comprises an aperture 50a near one of the J-shaped hooks 30g. The opposing upright members 30f are made from a flexible metal material to allow for side bending when pulled using linkages from a handle 44b on the outside of the chamber 12 opposing end 14b. When the handle 44b is placed in a relaxed position, the corresponding upright member 30f has an aperture 50a that is manipulated so that the aperture 50a is engaged by a mating pin 50b attached to an interior upper part of the chamber 12 that is co-linear with the respective mating support pin 30h.

As with many grilling systems, and especially systems that can be used as a convection oven, it is preferred that means 40 for monitoring an inside temperature of the chamber 12 when the cover is in use be provided. This can be done in a number of ways, however, it is preferred that a temperature gauge 42 be located on the cover 24 on a line approximating near is typical resting point within the chamber opening 22 as shown in the drawings or on the top area of the chamber 12 itself adjacent the opening 22.

In order to facilitate the handling of the chamber 12 when the system is broken down for transporting to places such as parks, tailgating at games, etc., or for shipping, chamber 12 can optionally be provided with handles 44a,44b on appropriate parts of the chamber 12 such as on the opposing ends 14a,14b.

A transport cover 46 can also be provided that can be used to grab the chamber 12 shortly after its use. The transport cover 46 is a saddle-shaped shroud that is configured to drape over the chamber 12 and substantially past a centerline of the chamber 12 with a center handle 46a at its apex 46b and opposing hooks 46c,46d at the side edges of the apex line, where the opposing hooks 46c,46d are configured and sized to engage with corresponding handles 44a,44b on the opposing upper ends 14a,14b of the chamber 12. This will ensure that the side of the chamber 12 itself does not come in contact with a person's leg or torso when moving the chamber 12.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A multiple function convection oven/grilling system comprising:
a chamber having an elongated generally cylindrical shape with two spaced-apart opposed ends;
said chamber being rotatably mounted on a stand, said stand having means for facilitating a rotation of said chamber about a central axis of said chamber;
said chamber having a saddle-shaped opening at an intermediate portion of said chamber, said opening extending from a first predetermined longitudinal level on a front side of said chamber to a second predetermined longitudinal level on a back side of said chamber;
a suspendable removable cover having a radius approximating a radius of said elongate cylindrical shaped chamber and configured and sized to have a width dimension less than a width of said saddle-shaped opening;
a fuel support rack for placing a charcoal or wood fuel thereon, said fuel support rack being configured to be placed in a spaced-apart overlying relationship to a bottom surface of said chamber; and
a suspendable food cooking grate removably mounted in a horizontal position in an interior of said chamber, said cooking grate being configured to maintain said horizontal position when said chamber is rotated.

2. The system according to claim 1, wherein said second predetermined longitudinal level of said saddle-shaped opening is at a level which is higher in elevation by a predetermined distance from said first predetermined longitudinal level on said front side of said chamber.

3. The system according to claim 1, wherein said stand is configured so as to cradle said chamber into a frame structure of said stand.

4. The system according to claim 1, wherein means for facilitating a rotation of said chamber about said central axis of said chamber comprises rollers at an upper portion of said stand, wherein a cylindrical shaped surface of said chamber rests on said rollers.

5. The system according to claim 4, further comprising:
means for holding said chamber in a first position wherein said charcoal or wood fuel is in a six o'clock underlying relationship to said food cooking grate and for holding said chamber in a rotated second position wherein said charcoal or wood fuel is in an intermediate orientation between six o'clock and nine o'clock relative to said food cooking grate.

6. The system according to claim 1, wherein the fuel support rack is generally arcuate shaped.

7. The system according to claim 1, further comprising:
a detachable fuel support rack portion configured to be attached to an intermediate portion of said fuel support rack, said detachable fuel support rack portion being directed inwardly so as to form a fuel holding basket portion for preventing said charcoal or wood fuel from falling off said fuel support rack when said chamber is rotated.

8. The system according to claim 1, wherein said food cooking grate further comprises one of an upright front edge, said upright front edge and an upright back edge, an upright left side edge and an upright right side edge, or a combination thereof.

9. The system according to claim 8, wherein said upright left side edge and said upright right side edge further comprise a plurality of spaced-apart notches extending from a front edge of said food cooking grate along at least a portion of said respective upright left and right side edges, said spaced-apart notches being configured to receive respective ends of a front edge of said cover.

10. The system according to claim 1, further comprising an air vent in the form of an aperture located near a bottom edge of one of said spaced-apart opposing ends.

11. The system according to claim 1, wherein the suspendable removable cover is configured to rest along an intermediate line of said removable cover on supporting members such that an air gap is created for additional air intake between a front edge of the removable cover and said first predetermined longitudinal level of the saddle-shaped opening and another air gap for exhausting heat and smoke between a back edge of the removable cover and said second predetermined longitudinal level of the saddle-shaped opening.

12. The system according to claim 1, further comprising means for monitoring an inside temperature of the chamber when said cover is in use.

13. The system according to claim 1, further comprising a handle on each of said opposing ends for facilitating a handling of said chamber.

14. The system according to claim 1, wherein said suspendable food cooking grate further comprises opposing upright members with a J-shaped hook at respective upper ends of said opposing upright members, said J-shaped hooks being configured to rotatably engage respective mating support pins.

15. The system according to claim 14, wherein said opposing upright members further comprises means for preventing said suspendable food cooking grate from swinging.

16. The system according to claim 15, wherein said means for preventing said suspendable food cooking grate from swinging comprises:
an aperture near one of said J-shaped hooks, wherein said opposing upright members are made from a flexible metal material and wherein said one of one of said upright members having said aperture is manipulated so that said aperture is engaged by a mating pin attached to an interior upper part of said chamber that is co-linear with one of said respective mating support pins.

17. The system according to claim 1, further comprising:
a transport cover configured as a saddle-shaped shroud that is configured to drape over and substantially past a centerline of said chamber;
a center handle located at an apex of said transport cover; and
opposing hooks at the side edges of an apex line of said transport cover, wherein said opposing hooks are configured and sized to engage with corresponding handles on upper edges of said opposing ends of said chamber.
